(19) United States
(12) Patent Application Publication
(10) Pub. No.: US 2026/0162194 A1
(43) Pub. Date: Jun. 11, 2026

(54) DYNAMIC POWER MANAGEMENT FROM AIRCRAFT POWER SYSTEM TO PASSENGER ELECTRONIC DEVICES BASED ON PASSENGER INFORMATION

(71) Applicant: Thales Avionics, Inc., Irvine, CA (US)

(72) Inventors: Kevin JUDD, Irvine, CA (US); Margaret STUART, Mission Viejo, CA (US)

(21) Appl. No.: 19/392,577

(22) Filed: Nov. 18, 2025

Related U.S. Application Data
(60) Provisional application No. 63/728,777, filed on Dec. 6, 2024.

(51) Int. Cl. G06Q 50/06; B64D 11/00; B64D 41/00

(52) U.S. Cl. CPC G06Q 50/06; B64D 11/00151; B64D 41/00; B64D 2221/00

(57) ABSTRACT

A power management system for supplying power from an aircraft electrical power source to PEDs. The power management system includes a plurality of power control circuits connected to power outputs configured to supply power to PEDs, and a power management circuit. The power management circuit obtains passenger-specific travel information associated with a passenger corresponding to a respective PED, and determines, based at least in part on the passenger-specific travel information, an allowed subscription power level for the respective PED. The power management circuit controls the power supplied to the respective PED via the respective power control circuit based on the determined allowed subscription power level. The operation to control the power supplied to the respective PED may include to negotiate with the respective PED an agreement for an agreed subscription power level that the respective PED is authorized to be supplied based on the determined allowed subscription power level.

### CROSS REFERENCE TO RELATED APPLICATIONS

This application claims priority to U.S. Prov. App. No. 63/728,777 filed Dec. 6, 2024, the disclosure and content of which are incorporated by reference herein in their entirety.

### TECHNICAL FIELD

The present disclosure relates to power management for passenger devices using aircraft power systems.

### BACKGROUND

There is an ever-increasing demand from passengers on commercial passenger aircrafts to power (charge) their portable personal electronic devices (“PEDs”), such as, for example, smart phones, tablet computers, laptop computers, virtual reality headsets, portable game consoles, etc. In addition, many commercial passenger aircrafts provide wireless Internet connection to such PEDs, which even more so increases the consumer demand to use PEDs on a flight to access the Internet for personal, as well as work purposes. This need can be challenging to satisfy in view of aircraft having a limited power supply from engine-driven generator(s).

There is a need in aircraft for a power management system that prevents an over-demand condition on the aircraft's electrical system, while also being able to supply power to a variable number and type of passenger PEDs that may connect to the system during a flight.

Existing systems in the industry that manage the power available to passenger PEDs can deny power to a newly connected PED in some manner, such as, for example, when other connected PEDs have already been allocated power such that insufficient remaining power is available for the newly connected PED. The primary reason existing systems deny power to some or all passenger PEDs is that such loads on the aircraft's electrical system by, in some cases, a large number of passengers (e.g., hundreds of passengers) simultaneously demanding power for their PEDs could overwhelm the aircraft's electrical system, resulting in an unsafe condition. For example, modern PEDs, including laptops, smart devices, and tablets, can draw anywhere from 2.5 W to 100 W. Such power consumption multiplied by hundreds of passengers could overwhelm the aircraft's electrical system in an unsafe manner. At the same time, denial of power to passenger PEDs, while not necessarily unsafe, is still an undesirable outcome and will likely reduce passenger satisfaction.

Universal Serial Bus (USB) is an increasingly pervasive industry standard that defines cables, connectors, and communication protocols used in a bus for connection, data communications, and power supply between computers and electrical devices, such as portable personal electronic devices. USB has become commonplace on laptop computers, smart phones, and tablet computers.

A passenger seat may include a USB Type C charging outlet that enables a PED to be powered by the aircraft electrical power through a USB Type C (USB-C) cable or through a wireless charging device (e.g., Qi standard). USB Type C builds on the USB 4 protocol published by the USB Implementers Forum (http://www.usb.org/home). USB Type C is also backwards compatible with older USB protocols.

Furthermore, a USB Power Delivery (USB PD) specification enables the delivery of higher power levels. The specifications for this technology can be found at http://www.usb.org/developers/powerdelivery/. The USB PD technology was developed to create a universal power plug for laptops, tablets, smart phones, etc. that may require more than 5 volts (V) using cables and plugs compatible with existing USB solutions. The USB PD specification defines a communication link between USB ports, e.g., connected via a cable supporting USB PD and connectors supporting USB PD. The USB PD specification permits power consumption of, e.g., up to 100 W, to support high power consuming portable devices, such as laptop computers. Unfortunately, existing power management systems for commercial passenger aircrafts have not been designed to support such high-power consuming devices within their fixed power supply environment.

Therefore, a need exists to overcome the problems with the prior art as discussed above.

### SUMMARY

Various embodiments of the present disclosure are directed to overcoming a limitation of prior power management systems where the total subscription power level that a power management system could agree to supply to a newly requesting PED was limited based on the total power supply levels which have been agreed to be supplied to other PEDs and a defined maximum power supply capability. This power management approach has been strictly followed despite that the PEDs' requested power subscription levels have been defined based on their respective highest-rated power scenarios. A PED's highest-rated power scenario may correspond to the total power that the PED is rated to draw while its battery is charging from a very low state-of-charge, its processor(s) are running at a highest rated speed, its mass storage device(s) is drawing highest rated power, its communication transceivers are drawing highest rated power, its display is set at a highest brightness and refresh rate, etc.

In accordance with present embodiments of this disclosure, a power management system is provided that determines an allowed subscription power level for a particular PED based on obtained information relating to the passenger associated with that PED along with other factors which can include the travel plans of the passengers. In some embodiments, the power management system determines subscription power levels allowed for PEDs based on the associated passengers' next flight schedule (if-any) on one or more aircraft, length of any layover that passengers' are predicted to experience awaiting boarding for a next flight on another aircraft, the determined availability of power at seats located at the terminal gate at which passenger will depart for next flight, determined availability of power at seats on another aircraft that will serve the next flight leg, etc. These and other embodiments are described in detail below.

Some embodiments are directed to a power management system for supplying power from an aircraft electrical power source to PEDs. The power management system includes a plurality of power control circuits connected to power outputs configured to supply power to PEDs, and a power management circuit. The power management circuit is configured to obtain passenger-specific travel information associated with a passenger corresponding to a respective PED, and determine, based at least in part on the obtained passenger-specific travel information, an allowed subscription power level for the respective PED. The power management circuit is further configured to control the power supplied to the respective PED via the respective power control circuit of the power management circuit based on the determined allowed subscription power level.

In a further embodiment, the operation by the power management circuit to control the power supplied to the respective PED includes to negotiate with the respective PED an agreement for an agreed subscription power level that the respective PED is authorized to be supplied by the power management system based on the determined allowed subscription power level. The negotiations may include to negotiate agreement on subscription power levels with PEDs using USB Power Delivery (USB PD) protocol signaling.

Other power management systems and corresponding methods and computer program products according to embodiments of the present disclosure will be or become apparent to one with skill in the art upon review of the following drawings and detailed description. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 illustrates a component block diagram of an aircraft communication system, satellites, and ground communication system which are configured to operate in accordance with various embodiments of the present disclosure;

FIG. 2 illustrates a power management system that includes power control circuits and a power management circuit which are configured to operate in accordance with various embodiments of the present disclosure; and

FIG. 3 illustrates a flowchart of optional operations by the power management circuit in accordance with various embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

As explained above, existing power management systems for commercial passenger aircrafts have not been designed to support high-power consuming devices used by numerous passengers during flights and, therefore, presents a multifaceted challenge tied to various constraints and uncertainties inherent in the systems.

As explained above, a limitation of prior power management systems is that the total subscription power level that could be agreed to be supplied to PEDs was limited to not exceed the maximum power supply capability of the power management system. This limitation was strictly followed despite the fact that the PEDs requesting power levels that can be based on their respective highest-rated power scenarios. As explained, a PED's highest-rated power scenario may correspond to the total power that the PED is rated to draw while its battery is charging from a very low state-of-charge, its processor(s) are running at a highest rated speed, its mass storage device(s) is drawing highest rated power, its communication transceivers are drawing highest rated power, its display is set at a highest brightness and refresh rate, etc. Because the PEDs may usually or nearly-always actually draw much lower power levels than their highest-rated power prior power management systems, this resulted in the power management system having power capacity that is reserved for use by some PEDs and therefore not available for use by other PEDs.

Moreover, prior power management systems have not been configured to consider the actual or predicted needs of the passengers for use of their respective PEDs during further travel plans beyond the present flight.

In accordance with various present embodiments of the disclosure, a power management system is provided that determines an allowed subscription power level for a particular PED based on obtained information indicating what the future PED charging needs may be for the passenger associated with that PED, which can include the travel plans of the passengers. In some embodiments, the power management system determines subscription power levels allowed for PEDs based on the associated passengers' next flight schedule (if-any) on one or more aircraft, length of any layover that passengers' are predicted to experience awaiting boarding for a next flight on another aircraft, the determined availability of power at seats located at the terminal gate at which passenger will depart for next flight, determined availability of power at seats on another aircraft that will serve the next flight leg, etc.

Before discussing the example operations of the power management system, an overview is provided of example components of aircraft and ground communication systems.

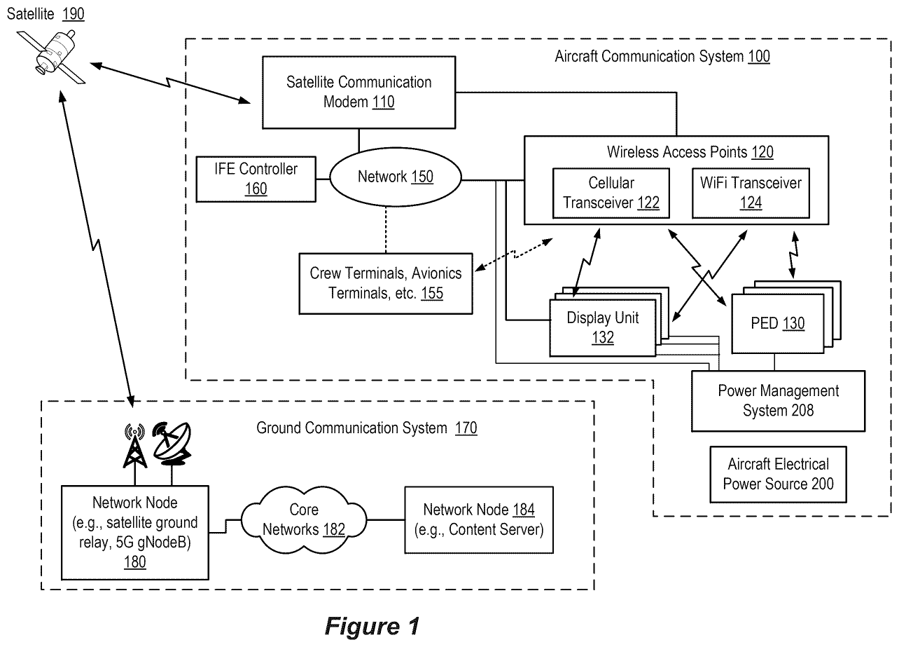

FIG. 1 illustrates a component block diagram of an aircraft communication system 100, satellite 190, and ground communication system 170 which are configured to operate in accordance with various embodiments of the present disclosure.

Referring to FIG. 1, the aircraft communication system 100 communicates with the ground communication system 170 using various communication technologies, e.g., proprietary satellite protocols, 3GPP 5G protocols, etc. More particularly, the aircraft communication system 100 includes a satellite communication modem 110 that transmits and receives signaling through one or more satellite antennas which is relayed by satellite(s) 190 to and from a radio communication network node 180 (e.g., satellite gateway, 5G gNodeB, etc.).

On the aircraft, signals received by the satellite communication modem 110 through satellite aperture antenna(s) are transported via RF link or Common Public Radio Interface (CPRI) interface (e.g., Ethernet or fiber optic links) and one or more networks 150 to wireless access points 120. The wireless access points 120 can include WiFi transceivers 124 (e.g., IEEE 802.11) or cellular transceivers 122 which may be configured to operate to retransmit data towards served terminals (e.g., passenger electronic devices (PEDs) 130, seat video display units 132 (e.g., In-Flight Entertainment (IFE) seat display units), cockpit terminals 144, crew terminals 144, avionics terminals 144, etc.). Similarly, the transceivers 122/124 can operate in a transport mode to receive and retransmit signals from the served terminals to the satellite communication modem 110 for transmission toward the satellite(s) 190 and relay to the network node 180.

An IFE controller 160 can communicate with ground-based network nodes 184, e.g., content servers (e.g., movies, TV programming, games, e-books, Internet content servers, etc.), through core networks 182 (e.g., private networks and/or public networks such as the Internet) and the network node 180, etc. The IFE controller 160 can operate as an on-board content server for locally stored content to the served terminals.

An aircraft electrical power source 200, typically from engine-driven generator(s), supplies power to components of the aircraft communication system 100. Moreover, as explained above, PEDs can be supplied power by the aircraft electrical power source 200 through, e.g., USB wired connections and/or wireless charging (e.g., Qi standard wireless power transfer). A power management system 208 is configured to manage power distribution to PEDS 130, and which may include negotiating power supply subscriptions with the PED 130. The power management system 208 may be configured to communicate through direct connections to the PEDs 130 or may communicate through the display unit 132 with the PEDs 130. Although the power management system 208 is illustrated as being separate from the display units 132, the power management system 208 may be at least partially integrated into each of the display units 132. Alternatively, the power management system 208 may be at least partially integrated into the IFE controller 160 or another component of the aircraft electronics. These and other operations of the power management system 208 are discussed below.

Although embodiments herein are primarily described in the context of in-flight entertainment solutions for an aircraft, the invention is not limited thereto. Instead, these and other related embodiments may be used with other types of vehicles, including, without limitation, ships (e.g., cruise ships), trains, subways, and buses. Accordingly, although various embodiments are described in the example context of involving passengers and crew, these and other embodiments can more generally be used by any persons (“users”).

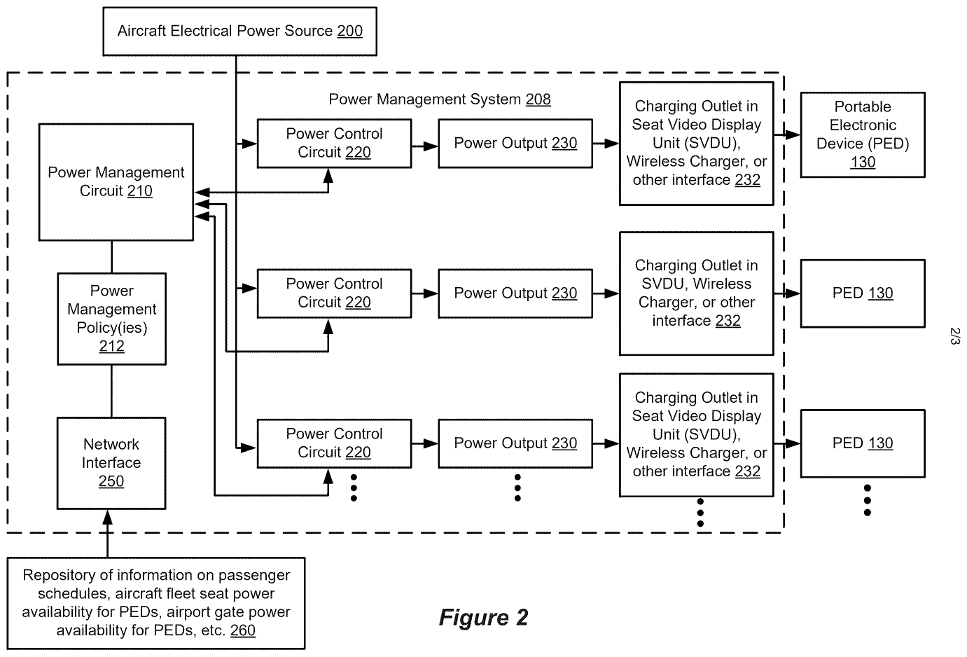

FIG. 2 illustrates a power management system 208 that includes power control circuits 220 and a power management circuit 210 which are configured to operate in accordance with various embodiments of the present disclosure.

Referring to FIG. 2, the power control circuits 220 are connected to power outputs 230 and, therethrough, to charging outlets 232 which may correspond to, e.g., USB-C standard connectors in seat video display units, in armrests, etc., and wireless charging interfaces (e.g., Qi standard charging interfaces), and/or other power supply interfaces which are operable to supply power for powering, e.g., charging, connected (e.g., via wired or wireless) PEDs 130.

Although FIG. 2 illustrates three sets of power control circuits, power outputs, charging outlets, and PEDs, a power management system for a commercial aircraft may have hundreds of such sets to enable passengers to charge one or more PEDs at any of the cabin seats. Moreover, a single power management circuit 210 may manage power supplied through any plural number of power outputs 230. Thus, for example, one power management circuit 210 may manage power supplied through all power outputs 230 in a cabin. Alternatively, a plurality of power management circuits 210 may be provided with each managing the power supplied a plurality of power outputs 230 for use by a passenger at a single seat, at a group of seats along a row, or at another correspondence of power outputs 230 to passenger seats, etc.

Although the power management circuit 210 is illustrated as being separate from the power control circuits 220, at least some of the operational functionality described herein may be incorporated into the power control circuits 220. Accordingly, the power management circuit 210 may be at least partially incorporated within the power control circuits 220.

The power control circuits 220 are configured to supply power from the aircraft electrical power source 200 to PEDs 130. Each of the power control circuits 220 may be configured to measure power supplied through one of the power outputs 230 to one of the connected PEDs 130 and to responsively generate a measured power indication. Although the number of power control circuits 220 is illustrated in FIG. 2 as being equal to the number of charging outlets 232, one or more of the power control circuits 220 may be configured to measure actual power supplied through more than one of the charging outlets 232, e.g., as a measurement of combined power supplied or as a sequential measurement performed through sequential temporary connections (e.g., through a multiplexer or other switched circuit) to measure one at a time the power supplied through a plurality of the charging outlets 232.

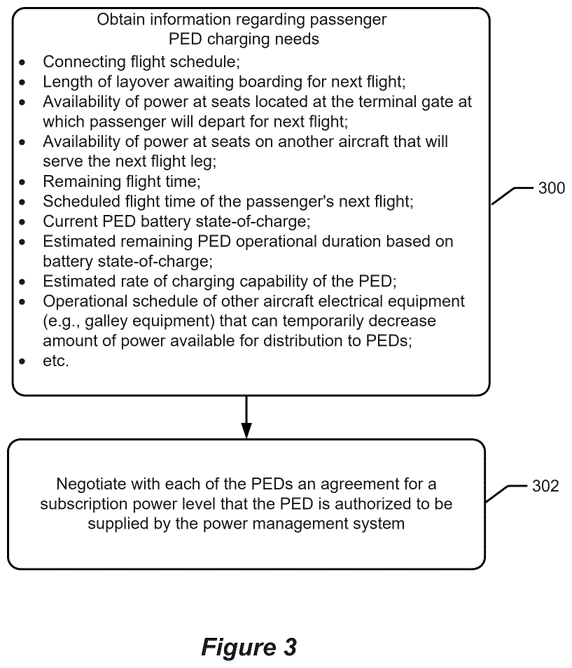

Operations performed by the power management circuit 210 are now described with further reference to the flowchart of FIG. 3. FIG. 3 illustrates a flowchart of optional operations by the power management circuit 210 in accordance with various embodiments of the present disclosure.

Referring to FIGS. 2 and 3, the power management circuit 210 is configured, for each of the PEDs 130, to perform operations to negotiate 300 with the PED 130 an agreement for a subscription power level that the PED 130 is authorized to be supplied by the power management system 208. In some embodiments the power management circuit 210 is configured to limit the total subscribed power levels to not exceed a maximum power supply capability of the power management system 208. In some other embodiments the power management circuit 210 is configured to allow an oversubscription state by operations agreeing to subscription power levels for the PEDs 130 that when combined into a total subscription power level exceeds the maximum power supply capability of the power management system 208. The maximum power supply capability of the power management system 208 may correspond to a rated maximum power level that can be supplied by the power management system 208 and/or a maximum power level that is allowed to be supplied to the power management system 208 by the aircraft electrical power system 200. The power control circuit 220 is configured to control the power level supplied to the connected PED 130 based on the subscription power level for the PED 130 and/or based on a command from the power management circuit 210, e.g., a command to cease or adjust the supplied power level.

When the power management circuit 210 allows an oversubscription state to occur, the power manager circuit 210 determines for each of the PEDs 130 a present actual power usage of the PED 130 based on the measured power indication from one of the power monitor and control circuit 220 measuring actual power supplied through the power output 230 connected to the PED 130. The power manager circuit 210 determines a present total actual power usage of the PEDs 130 based on a combination of the measured power indications from the power monitor and control circuits 220. Responsive to determining that the present total actual power usage of the PEDs 130 exceeds the maximum power supply capability of the power management system 208 minus a threshold offset, the power manager circuit 210 renegotiates an agreement with at least a particular one of the PEDs 130 for a lower subscription power level that the particular PED 130 is authorized to be supplied so that the total actual power usage of the PEDs 130 will cease exceeding the maximum power supply capability of the power management system 208 minus the threshold offset.

According to various present embodiments, the power management circuit 210 is configured to determine an allowed subscription power level for a particular PED based on obtained information relating to the further PED charging needs of a passenger, which can be determined based on travel plans of the passenger associated with that PED along with other factors. The power control circuit 220 can include a network interface 250 that can allow it to communicate with the IFE controller 160, crew terminals 155, other avionic terminals 155, etc. via the cabin network(s) 150.

In some embodiments, the power management circuit 210 obtains 300 information indicating passengers' future PED charging needs and uses that information to manage the maximum level of power that is delivered to PEDs associated with those passengers. The power management circuit 210 can use the information as an input to control negotiations 302 with each of the PEDs associated with those passengers (which are inserted into the power outputs 230 for charging) for what subscription power levels will be authorized to be supplied by the power control circuits 220. In this manner, the power management circuit 210 can more fairly allocate limited power resources to PEDs for charging based on the future PED charging needs that are determined for the associated passengers.

Pursuant to various present embodiments, the power management circuit 220 accesses a repository 260 of information identifying passengers' flight schedules, aircraft fleet seat power availability for passengers to charge PEDs, airport gate power availability for passengers to charge PEDs while waiting to board connecting flights, and other information associated with passengers' ability to obtain power for charging their PEDs: while traveling on the present aircraft; while waiting in a terminal gate area to board a connecting flight; while traveling onboard an aircraft during a connecting flight toward a destination; and/or upon arrival and traveling toward a final destination by other mode of transportation (e.g., train, subway, bus, car, etc.). The power management circuit 220 is configured to manage the delivery of power to passengers' PEDs based on such information or combinations of such information to enable more intelligent allocation of limited power resources toward passengers who are determined to potentially benefit the most according to one or more power management policies 212 which may also be obtained from the repository 260.

The repository 260 may reside wholly or partially in the IFE controller 160, in one or more other components of the aircraft communication system 100, and/or in a ground network node 184 which is accessible through wireless communication connectivity via the satellite communication modem 110 and ground communication system 170. Information in the repository 260 may include, without limitation:
passenger manifests which may indicate passenger names, seating assignments, frequent flyer status, seat assignment and/or class, and travel schedules;
aircraft equipment information indicating seat power availability, and may further indicate type of power available for charging such as USB-A, USB-C, USB-PD, alternating current plug, etc. and maximum USB power levels available for particular seats or categories of seats, e.g., assigned passenger seat for connecting flight or class of seating (first class, business class, premium economy, economy, etc.); and/or
airport terminal gate configuration information indicating

power availability for charging PEDs, and may further indicate type of power available for charging such as USB-A, USB-C, USB-PD, alternating current plug, etc. and maximum USB power levels available.

In one embodiment, the power management circuit 220 obtains a connecting flight schedule for a passenger, and uses the connecting flight schedule to manage the maximum level of power that is allowed to delivered to a PED associated with that passenger.

When a passenger inserts a PED 130 into one of the outlets 232 for charging, the power management circuit 210 can operate to identify the passenger based on an identifier of the PED 130, such as based on a phone serial number, phone mobile identifier, phone number, name assigned to phone by passenger, phone Embedded Identity Document (EID), ID from phone Subscriber Identity Module (SIM), ID from embedded SIM (e-SIM), etc.

Alternatively or additionally, the power management circuit 210 can operate to identify the passenger by looking up passenger information (e.g., passenger name) using an identifier associated with the charging outlet 232 in which the PED 130 was inserted, such as by querying a passenger manifest (e.g., in repository 260) using a seat number associated with that outlet 232 to identify a passenger name who is associated with (assigned to) that seat number. Because the charging outlets 232 are typically integrated within a seating surface (e.g., in a seat VDU 132, seat armrest, etc.), the power management circuit 210 can correlate a particular charging outlet with a particular seat location, which can then be correlated to a particular passenger (e.g., via a passenger manifest or other manner such as described herein).

Alternatively or additionally, the power management circuit 210 can operate to identify the passenger by receiving information from an application hosted on the PED 130 (e.g., Internet browser, gaming application, airline application, etc.) which may become communicatively connected to the IFE controller 160 or other element of the system 100 for purposes of obtaining Internet connectivity and/or streaming content through the satellite communication modem 110 to the ground communication system 170, obtaining IFE content from the IFE controller 160, pairing of the PED 130 to a seat video display unit (VDU) 132 to enable the passenger to remotely control the VDU and/or stream content to and/or from the VDU (e.g., screen mirroring, screen casting), etc.

Still alternatively or additionally, the power management circuit 210 can operate to identify the passenger based on information provided by the passenger through a seat VDU 132 during a registration or other passenger participation process to obtain services provided through the IFE controller 160 or other element of the system 100.

In one operational embodiment, the power management circuit 220 uses the connecting flight schedule to determine whether a passenger who has inserted a PED into the outlet 232 for charging, has a scheduled connecting flight on another aircraft that will (or will not) provide an opportunity for that passenger to charge the PED at the assigned seat during the next flight. Responsive to when the determination is that the passenger is scheduled on another flight that will not provide PED charging at the passenger's seat, the power management circuit 220 can prioritize providing a higher power level, e.g., grant a higher subscription power level, to that passenger's PED during the current flight so that the passenger's PED can have a higher battery state-of-charge at the end of the current fight and which may support a sufficient PED operational duration for the duration of the connecting flight.

The connecting flight schedule may be obtained from the repository 260 and used to retrieve information from an aircraft fleet seat power availability database that indicates which seats, if any, (on a particular aircraft or type of aircraft which corresponds to the passenger's connecting aircraft) are configured to provide power to charge passenger PEDs. When only certain seats on the connecting aircraft (e.g., defined seat numbers or seats in defined seating section, e.g., premium class sections) are configured to provide charging power, the passenger's connecting flight schedule may be used to determine the passenger's assigned seat, which can be then be used to identify whether the passenger associated with the power requesting PED will have power at that passengers assigned seat or defined seating section on the next aircraft.

In a further operational embodiment, the power management circuit 220 determines the scheduled flight time of the passenger's connecting (next) flight and manages the maximum level of power that is allowed to delivered to the PED based on the scheduled flight time of the passenger's connecting flight. The power management circuit 220 may prioritize providing a higher power level, e.g., grant a higher subscription power level, to that passenger's PED responsive to the next schedule flight time exceeding a defined threshold duration. The power management server 220 may adapt its power management decisions based on a determination of a present state-of-charge of the PED, an estimation of how much the PED state-of-charge can be increased through charging on the current flight in view of the remaining flight time of the current flight, and a related estimation of whether the PED will have a battery state-of-charge at the end of the current fight which will be sufficient to sustain PED operation during the duration of the passenger's connecting flight.

An example operation by the power management circuit 220 to determine the present state-of-charge of a PED can include to communicate with the PED through Bluetooth, e.g., when the PED is paired through Bluetooth with a VDU, and query the PED operating system and/or an airline application on the PED to obtain an indication of the present state-of-charge of a PED.

In an additional or alternative operational embodiment, the power management circuit 220 uses the connecting flight schedule to determine whether a passenger who has inserted a PED into the outlet 232 for charging, has a scheduled connecting flight through an airport terminal gate area that will (or will not) provide an opportunity for that passenger to charge the PED at the seats in the gate area while awaiting boarding for the connecting flight, e.g., whether the gate area seats have USB charging outlets allowing direct PED charging or have alternating current (AC) outlets allowing PED chargers to be inserted for charging PEDs. Responsive to when the determination is that the seats in the gate area do not provide power output for PED charging, the power management circuit 220 can prioritize providing a higher power level, e.g., grant a higher subscription power level, to that passenger's PED during the current flight so that the passenger's PED can have a higher battery state-of-charge at the end of the current fight and which may support a sufficient PED operational duration for the duration of that the passenger may be in the gate area while awaiting boarding for the connecting flight.

In a further operational embodiment, the power management circuit 220 manages the level of power supplied to PEDs based on other factors that affect how much power is available now or in the future for use by passengers for power PEDs.

In one operational embodiment, the power management circuit 220 manages the level of power supplied to PEDs based on a schedule for when electrical equipment in the galley will be used by crew and/or based on a notification indicating that such electrical equipment is starting to become used by crew (i.e., powered-on or transitioned to a higher power state) or a notification indication that such electrical equipment has become inactive (i.e., powered-off or transitioned to a lower power state). The power management circuit 220 may, for example, be notified by a crew member through a crew terminal 144 that the galley equipment will start to be used to heat passenger meals or beverages at an indicated time, has presently started to be used, and/or has ceased being used, and/or to provide a schedule of planned use of the galley equipment. The term “schedule” may indicate a time of day or a defined time in the future from a present time (e.g., countdown time).

When the galley equipment is not being used, a power budget that was reserved for use by that equipment may be made available for use by the power management circuit 220 for providing to PEDs 130, which the power management circuit 220 can be informed of through corresponding signaling. In contrast, while the galley equipment is being used, power that is budgeted for use by that equipment should cease being used by the power management circuit 220 for providing to PEDs 130, which the power management circuit 220 can be informed of through corresponding signaling.

The power management circuit 220 can be configured through one or more power policies (e.g., obtained from repository 260) to prioritize how much power is made available for use by different passengers' PEDs 130 based on information associated with the passengers (e.g., airline rewards status, passengers' who purchased or obtained premium rights such as by purchasing Internet connectivity package(s), etc.) and/or information associated with the PEDs 130 including, without limitation: type of PED (e.g., laptop, tablet, phone, augmented reality/virtual reality headset, wireless headphones, etc.); power requirements of the PED; rate at which the PED battery state-of-charge can be increased; present PED battery state-of-charge; estimated operational time of the PED based on its present battery state-of-charge; number of PEDs that a passenger is attempting to charge using a port extender/replicator device (e.g., a device which plugs into a power output 230 and feeds power through USB connectors to a plurality of plugged-in PEDs); etc.

The negotiation 302 operations can be performed using the USB Power Delivery (USB PD) protocol according to the USB-C standard to enable faster charging and increased power delivery capabilities of the power management system 208 to PEDs 130. Based on using the USB PD protocol, when a USB-C connection is in an attached state, USB PD negotiation occurs between the power management circuit 210 (e.g., via operation of the power control circuit 220) and a PED 130, allowing for the negotiation of power delivery modes and values and agreement of a subscription power level to be supplied to the PED 130.

The negotiation 302 and/or renegotiation may include negotiations/renegotiations with the PEDs 130 based on a fair share policy applied to passengers' future charging needs as described above to determine allocation of subscription power levels for the PEDs 130, and which may further influence allocation of subscription power levels for the PEDs 130 based on at least one of: comparison of durations that the PEDs 130 have been supplied power under present subscription power levels; comparison of the present subscription power levels; and comparison of power levels originally requested by the PEDs 130. Thus, for example, a PED that has been charging longer duration and is associated with a passenger having a determined lower future PED charging need may be provided a lower subscription power level than another PED that has been charging for a shorter duration and has a determined greater future PED charging need.

Further optional operations by the power management circuit to negotiate subscription power levels with the PEDs are now described in accordance with various embodiments. When a USB-C connection is in an attached state, the power management circuit 210 (e.g., via operation of the power control circuit 220) performs negotiation 302 of a subscription power level with the attached PED 130. The operations first identify the capabilities of the USB-C connection before sending a source capabilities message to the PED 130 containing power data objects (PDOs). The PDOs indicate different voltage and current values, allowing for flexibility in charging different PED requirements. For example, a phone may only use up to 9 Volts at 3 Amps. In contrast, a laptop computer may use up to 20 Volts at 5 Amps. Supporting a variety of PDOs allows each PED 130 to pick one of the PDOs which satisfies its electrical power supply needs and compatibilities. Assuming the PED 130 is capable of USB PD, it can respond to the source capabilities message with a request data object (RDO) which is received by the power management circuit 210. The RDO indicates a PDO index (identifying one of the PDOs identified in the source capabilities message) and includes additional information about the requested voltage and/or current. The power management circuit 210 then responds with an accept message or reject message. If accepted, the power management circuit 210 (e.g., via operation of the power control circuit 220) changes the supplied voltage and current before sending back a power supply ready message (PS Ready). The PS Ready establishes the subscription power level to be supplied to the PED 130 and signals that the PED 130 can begin drawing (consuming) the requested power level specified in the RDO.

The PDOs may be of three types: fixed, variable, or battery. Fixed PDOs are for a pre-defined fixed voltage with a maximum current value. For example, 5v output of a legacy non-USB-C port can be handled by fixed PDOs along with 9v, 12v (deprecated), 15v, and 20v. Variable PDOs are for power supplies that swing in voltage between an advertised minimum and maximum with a maximum current value. Battery PDOs are for direct connections with a battery and specify minimum and maximum voltage with maximum power.

Augmented Power Data Objects (APDO) may be used as an extension of the original PDOs provided in USB PD. APDOs expose additional power delivery objects such as Standard Power Range Programmable Power Supply (SPR) and Extended Power Range Adjustable Voltage Supply (EPR). SPR covers a voltage range, e.g., from 3.3 to 21 volts, while EPR covers another voltage range, e.g., from 15 to 48 volts. These modes allow for fine control by the power management circuit 210 (e.g., via operation of the power control circuit 220) over the power supplied (e.g., during PED charging), including setting different voltage and current values throughout charging. The power management circuit 210 (e.g., via operation of the power control circuit 220) may operate to supply power in a constant current mode at the RDO current setpoint allowing for constant current supply to a PED 130.

As explained above in accordance with various present embodiments, when the power management circuit 210 performs the negotiation 302 with an attached (e.g., PED 130 plugged into a USB-C charging outlet 232) for an agreement to a subscription power level that the PED 130 is authorized to be supplied by the power management system 208, the power management circuit 210 is configured to use obtain information indicating the future charging needs of the passenger, which may include any one or more of the informational items obtained in operation 300.

A PED's state-of-charge may be estimated based on a data object received from the PED (e.g., the PED may report its state-of-charge or may be queried to provide an indication of the state-of-charge) or based on a profile of the power level measurements over time for the PED (e.g., a battery having a low state-of-charge (e.g., less than 30%) can draw more power than when the battery has a high state-of-charge (e.g., more than 70%) based on chemical characteristics and configuration of the battery).

Optional alternative operations can be performed by the power management circuit 210 to prioritize which PEDs 130 are prioritized for renegotiation of lower subscription power levels, in accordance with various embodiments of the present disclosure. The operations include to estimate present state-of-charge of the PEDs 130, and to prioritize performing renegotiation of agreements with the PEDs 130 having the highest present state-of-charge (and having a lower determined future charging need during a layover and/or next flight) to provide lower subscription power level to be supplied by the power management system 208. In this manner, PEDs 130 which have higher battery state-of-charge would be renegotiated to receive lower subscription power levels before PEDs 130 and, if completion of those renegotiations sufficiently lowers the total actual power usage of the PEDs 130 then other PEDs 130 which has lower battery state-of-charge may not have their existing subscription power levels changed (lowered).

The operation to prioritize may include to generate a list of the PEDs 130 ordered based on their relative present state-of-charge and with PEDs 130 and determined future PED charging needs of the passenger as described above, where PEDs with lower present state-of-charge ordered and higher future charging needs are placed higher in the list than other PEDs 130. The operation can then prioritize performing renegotiation of agreements, to provide higher subscription power levels to be supplied by the power management system 208 to PEDs 130 having a relatively higher position in the list.

Passengers may be notified by the power management system 208, e.g., in cooperative operation with the IFE controller 160, through their PEDs 130 and/or their assigned seat VDUs 132 when their respective plugged-in PED 130 is being prioritized for charging in view of the passenger's determined future charging needs. A passenger may thereby be notified that because of any one of more of the information elements described above with regard to operation 300, the passenger's PED is being provided a higher level of power and/or for a longer duration to enable the passenger to for example, continue to use the PED throughout the duration of the passenger's airport terminal layover awaiting boarding for the next flight and/or for the duration of the passenger's next flight which is determined to not have available power at the passenger's seat for PED charging. These and other operations can provide increased passenger satisfaction and resulting loyalty with the airline.

Further notifications by the power management system 208 may provide PED charging guidance (advice) to passengers. For example, the power management system 208 may notify a passenger, e.g., via the VDU and/or PED, that based on a PED state-of-charge and an estimated layover time at the next airport awaiting a next flight, that the passenger will have insufficient time to charge the PED to more than an indicated percentage level. The operations may notify a passenger whether the passenger's gate for the next flight has power available in the seating area for charging PEDs and/or indicate where in the terminal the passenger can obtain access to such power, e.g., at a designated PED power charging zone near the passenger's gate. The operations may notify a passenger whether the aircraft serving the passenger's next flight will provide seat power for charging the PED. Other passenger notifications can be provided in view of the other embodiments disclosed herein.

### Further Definitions and Embodiments

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

1. A power management system for supplying power from an aircraft electrical power source to passenger electronic devices (PEDs), the power management system comprising:
a plurality of power control circuits connected to power outputs configured to supply power to PEDs; and
a power management circuit configured to:
obtain passenger-specific travel information associated with a passenger corresponding to a respective PED;
determine, based at least in part on the obtained passenger-specific travel information, an allowed subscription power level for the respective PED; and
control the power supplied to the respective PED via the respective power control circuit of the power management circuit based on the determined allowed subscription power level.

2. The power management system of claim 1, wherein the operation of the power management circuit to control the power supplied to the respective PED via the respective power control circuit of the power management circuit based on the determined allowed subscription power level, comprises to:
negotiate with the respective PED an agreement for an agreed subscription power level that the respective PED is authorized to be supplied by the power management system based on the determined allowed subscription power level.

3. The power management system of claim 2, wherein the power management circuit is configured to negotiate agreement on subscription power levels with PEDs using USB Power Delivery (USB PD) protocol signaling.

4. The power management system of claim 1, wherein the passenger-specific travel information includes at least one of:
a connecting flight schedule for the passenger;
a layover duration for the passenger;
availability of PED charging power at a terminal gate associated with the passenger; and
availability of PED charging power at a seat assigned to the passenger on a connecting aircraft.

5. The power management system of claim 1, wherein the power management circuit is configured to obtain the passenger-specific travel information from a repository accessible to the aircraft, the repository including at least one of: passenger manifests, aircraft fleet seat power availability data, and airport terminal gate power availability data.

6. The power management system of claim 1, wherein the power management circuit is configured to identify the passenger corresponding to a respective PED using at least one of:
an identifier reported by the PED;
a seat-to-outlet mapping correlated to a passenger manifest;
credentials provided by an application on the PED; and
passenger input via an in-seat display unit.

7. The power management system of claim 1, wherein the power management circuit is configured to determine the allowed subscription power level for a PED based on a determined connecting flight schedule associated with the passenger.

8. The power management system of claim 1, wherein the power management circuit is configured to determine the allowed subscription power level for a PED based on a determining layover duration associated with the passenger.

9. The power management system of claim 1, wherein the power management circuit is configured to determine the allowed subscription power level for a PED based on determining availability of PED charging power at a terminal gate associated with the passenger.

10. The power management system of claim 1, wherein the power management circuit is configured to determine the allowed subscription power level for a PED based on determining availability of PED charging power at a seat assigned to the passenger on a connecting aircraft.

11. The power management system of claim 1, wherein the allowed subscription power level for a PED is increased based on determining that at least one device among galley equipment is not in use.

12. The power management system of claim 1, wherein the power management circuit is configured to apply a power allocation policy that prioritizes providing higher allowed subscription power levels to PEDs associated with passengers who are determined to have limited future charging opportunities.

13. The power management system of claim 1, wherein the power management circuit is configured to apply a power allocation policy that considers passenger attributes selected from the group consisting of:
frequent flyer status;
cabin class of passenger seat;
purchase of premium services; and
purchased network connectivity tiers.

14. The power management system of claim 1, wherein the power management circuit is configured to notify a passenger via the passenger's PED and/or an in-seat display unit when the PED is prioritized for a higher allowed subscription power level based on the passenger-specific travel information.

15. A method performed by a power management system of an aircraft, the power management system including a plurality of power control circuits connected to power outputs configured to supply power to passenger electronic devices (PEDs), the method comprising:
obtaining passenger-specific travel information associated with a passenger corresponding to a respective PED;
determining, based at least in part on the obtained passenger-specific travel information, an allowed subscription power level for the respective PED; and
controlling the power supplied to the respective PED via the respective power control circuit of the power management circuit based on the determined allowed subscription power level.

16. The method of claim 15, wherein the controlling of the power supplied to the respective PED via the respective power control circuit of the power management circuit based on the determined allowed subscription power level, comprises to:
negotiating with the respective PED an agreement for an agreed subscription power level that the respective PED is authorized to be supplied by the power management system based on the determined allowed subscription power level.

17. The method of claim 15, wherein the passenger-specific travel information including at least one of:
a connecting flight schedule for the passenger;
a layover duration for the passenger;
availability of PED charging power at a terminal gate associated with the passenger; and
availability of PED charging power at a seat assigned to the passenger on a connecting aircraft.

18. The method of claim 15, further comprising:
obtaining the passenger-specific travel information from a repository accessible to the aircraft, the repository including at least one of: passenger manifests, aircraft fleet seat power availability data, and airport terminal gate power availability data.

19. The method of claim 15, further comprising:
identifying the passenger corresponding to a respective PED using at least one of:
an identifier reported by the PED;
a seat-to-outlet mapping correlated to a passenger manifest;
credentials provided by an application on the PED; and
passenger input via an in-seat display unit.

20. The method of claim 15, further comprising:
applying a power allocation policy that prioritizes providing higher allowed subscription power levels to PEDs associated with passengers who are determined to have limited future charging opportunities.

21. The method of claim 15, further comprising:
notifying a passenger via the passenger's PED and/or an in-seat display unit when the PED is prioritized for a higher allowed subscription power level based on the passenger-specific travel information.

22. A non-transitory computer-readable medium storing instructions executable by at least one processor of a power management system of an aircraft, the instructions when executed causing the at least one processor to perform operations comprising:
obtaining passenger-specific travel information associated with a passenger corresponding to a respective PED;
determining, based at least in part on the obtained passenger-specific travel information, an allowed subscription power level for the respective PED; and
controlling the power supplied to the respective PED via the respective power control circuit of the power management circuit based on the determined allowed subscription power level.
